(19) United States
(12) Patent Application Publication
(10) Pub. No.: US 2015/0131405 A1
(43) Pub. Date: May 14, 2015

(54) MAGNETIC MIXING FOR CONTINUOUS LATEX PREPARATION

(71) Applicant: XEROX CORPORATION, Norwalk, CT (US)

(72) Inventors: Ke Zhou, Oakville (CA); Yu Liu, Burlington (CA); Jun Zhao, Mississauga (CA); C. Geoffrey Allen, Waterdown (CA); Yulin Wang, Oakville (CA); Frank Ping Hay Lee, Oakville (CA)

(73) Assignee: XEROX CORPORATION, Norwalk, CT (US)

(21) Appl. No.: 14/075,263

(22) Filed: Nov. 8, 2013

(51) Int. Cl. B01F 13/08; B01F 15/06; B01F 15/02

(52) U.S. Cl. CPC B01F 13/0818; B01F 15/0243; B01F 15/06; B01F 2015/061; B01F 2015/062; B01F 2215/005
USPC 366/144; 366/182.2

(57) ABSTRACT

A mixing process and system for mixing fluid such as a latex can include a first fluid and a second fluid that are combined to form, for example, a latex precursor. A plurality of magnetic particles are dispensed within the precursor. The precursor is dispensed within a mixing zone that may include a mixing tube. Two or more opposing electromagnets are activated out of phase (i.e., out of sync) to affect a travel path of the magnetic particles to form a turbulence within the precursor to provide an effective mixing of the precursor to form a material such as latex. The magnetic particles may be removed from the material, for example by filtering, or may remain within the material during use.

### TECHNICAL FIELD

The present teachings relate to the field of fluid manufacture and, more particularly, to a method and system for mixing a solution such as a latex precursor to form a material such as a latex in a continuous mixing system.

### BACKGROUND

In industry, batch processes may be used to form a desired quantity of a material such as a fluid. However, it is typically difficult to control and minimize batch-to-batch variations. Once quality standards for a particular batch are not met, an entire batch is often rejected and scrapped prior to completion of the batch to prevent further waste of raw materials.

In many batch processes, mixing of a fluid may be a critical process that determines an overall performance of the completed material. For example, in applications where small-sized particles are produced, achieving the small scale and uniform distribution of the particles is performed by the mixing process. Present mixing methods and systems may provide less than uniform mixing efficiency across an entire mixing zone. Mixing of a solution may be localized at a central mixing point rather than through the entire mixing zone, for example at a location where an impeller tip is used for agitation of the solution. Mixing efficiency may decay with increasing distances of the fluid from the impeller tip. Additionally, dead spots or shallow spots with inefficient mixing resulting from fluid turbulence and eddies may be distributed along edges of a shaft to which the impeller is mounted. Furthermore, a curved vessel or container may result in insufficient mixing.

Other mixing systems and methods may require more complex equipment setups and may have other undesirable characteristics, such as an increased number of mechanical parts that must be serviced and repaired. In another type of system, acoustic techniques have been employed in an attempt to avoid inefficient mixing. An acoustic mixing system may include a non-contact technique to provide micro scale mixing within a micro zone of about 50 μm in a closed vessel. However, generating an acoustic wave relies on mechanical resonance as controlled by engineered plates, eccentric weights, and springs. Particular care and protection of the mechanism that is used to generate mechanical resonance may be employed because small turbulence may damage the system. Therefore, the overall service life of an acoustic system is limited to the effective lifetime of the mechanical components. Thus, such systems may require extensive and expensive mechanical maintenance. Further, as mentioned above relative to a mixing system that uses an impeller, acoustic energy and thus mixing efficiency decays at increasing distances of the fluid away from the acoustic wave source.

Though batch processing is a common manufacturing technique that is sufficient for many technologies, it can be wasteful and may complicate future project planning. In an attempt to overcoming the deficiencies of batch processing, continuous processing of a material may be practiced, depending on the industry. See, for example, US Patent Publication 2011/0015320 and U.S. Pat. No. 8,168,699, each of which is incorporated herein by reference in its entirety. In continuous processing (i.e., continuous flow process or continuous production), processing of dry or fluid material occurs continuously rather than in batches or lots. Constant efforts to develop new and facile processes with compact system designs and effective energy savings would be beneficial for process maintenance, lowering production costs, and enhanced process robustness.

Solvent-based phase inversion processes have been used for the batch preparation of latex. See, for example, US Pub. 20100310979, which is commonly assigned herewith an incorporated herein by reference in its entirety. However, preparing a toner, such as a toner for use in forming print and/or Xerographic images, using an inversion process is costly.

Thus, there is a need for a new and improved mixing method and system that overcomes various problems that may be encountered with some mixing systems.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

In an embodiment, a system for mixing a fluid may include a first pump in fluid communication with a first fluid supply and configured to pump a first fluid from the first fluid supply to a receptacle, a second pump in fluid communication with a second fluid supply and configured to pump the second fluid from the second fluid supply to the receptacle, a first electromagnet having a first phase and a second electromagnet having a second phase, wherein the receptacle is interposed between the first electromagnet and the second electromagnet, and a controller configured to activate the first phase out of phase with the second phase.

In another embodiment, a system for mixing a fluid may include a first pump in fluid communication with a first fluid supply and configured to pump a first fluid from the first fluid supply to a receptacle, a second pump in fluid communication with a second fluid supply and configured to pump the second fluid from the second fluid supply to the receptacle, an electromagnet comprising a first phase and a second phase, wherein the receptacle is interposed between the first phase and the second phase, and a controller configured to activate the first phase out of phase with the second phase.

In another embodiment, a method for continuous mixing of a fluid may include pumping a first fluid from a first fluid supply into a mixing receptacle using a first pump, pumping a second fluid to be mixed from a second fluid supply into the mixing receptacle using a second pump, wherein the first fluid within the mixing receptacle and the second fluid within the mixing receptacle form a solution to be mixed, introducing a plurality of magnetic particles into the mixing receptacle, wherein the plurality of magnetic particles are within the solution to be mixed, activating a first electromagnet phase, and activating a second electromagnet phase out of phase with the activation of the first electromagnet phase as the solution to be mixed and the magnetic particles are within the mixing receptacle, thereby altering a travel path of the plurality of magnetic particles within the solution to be mixed, wherein the mixing receptacle is interposed between the first electromagnet phase and the second electromagnet phase.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a cross section depicting a system for continuous mixing of a fluid or solution within a mixing zone in accordance with an embodiment of the present teachings; and

FIG. 2 is a schematic perspective depiction (ghost view) of a portion of a continuous mixing system in accordance with an embodiment of the present teachings.

It should be noted that some details of the FIGS. have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same or like parts.

The disclosed embodiments relate generally to a method and system for a continuous mixing process that includes magnetic actuated mixing of a prepared fluid, such as a latex material. Embodiments may include the use of magnetic particles actuated using an electromagnetic field to increase mixing efficiency compared to some conventional methods and systems. Embodiments of the present teaching may include a continuous process for manufacturing polyester latex for emulsion aggregation (EA) toner applications. In an embodiment, a neutralized resin solution may be brought into initial contact with deionized water (DIW) by being continuously pumped together using separate feeding pumps, then mixed by the movement of magnetic particles under oscillating magnetic field. In an embodiment, the magnetic mixing system may eliminate the need for an external mixer. Further, a mixing zone within which mixing occurs may be designed with a three-dimensional (3D) shape or geometry that is selected to enhance mixing. A system in accordance with the present teachings may provide a mixing method and system that reduces the cost of product manufacturing compared to some mixing methods and systems. The present embodiments may provide a system with reduced device complexity and a simplified and less costly system maintenance compared to some conventional mixing systems.

Various geometric designs of the mixing zone are contemplated. As an embodiment may use micro size magnetic particles for mixing, the embodiment does not require an external mixer and thus the mixing zone may be designed with a desired shape to enhance production or mixing. A varying magnetic field in accordance with an embodiment of the present teachings may be provided by one or more electromagnets powered, for example, with direct current (DC) and/or alternating current (AC). The mixing zone may include a horizontal flowing direction, a vertical flowing direction, or a flowing direction that is between horizontal and vertical. An embodiment may allow for the increase of reactant loading in a compact layout, thus enhancing heat transfer effectiveness, reducing manufacturing cost, providing a simplified mixing system design, and providing a system that is accessible and easily maintained.

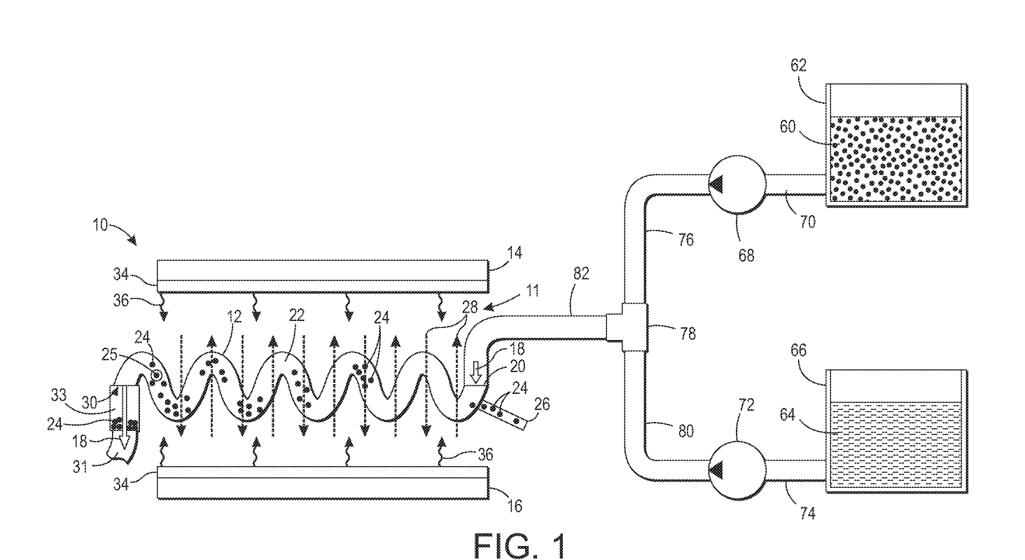

An exemplary mixing zone 11 of a mixing system, apparatus, or structure 10 and process in accordance with an embodiment of the present teachings is depicted in the schematic cross section of FIG. 1. The FIG. 1 system may include a receptacle 12, for example a mixing tube 12, such as a glass, plastic, polymer, quartz, or metal receptacle interposed between at least a first electromagnet phase 14 and an opposing second electromagnet phase 16. In an embodiment, the first electromagnet phase 14 and the second electromagnet phase 16 may be two phases of a single electromagnet. In another embodiment, the first electromagnet phase 14 may be a first phase of a first electromagnet and second electromagnet phase 16 may be a first phase of a second electromagnet. An apparatus in accordance with the present teachings may include more than two electromagnets or electromagnet phases, such as an electromagnet coil that surrounds the mixing tube 12, for example through 360°, with a plurality of electromagnets or a single electromagnet having more than two phases.

During a continuous mixing process, a fluid (i.e., solution or mixture) 18 to be mixed is injected or otherwise dispensed through a tube inlet 20 into a hollow center 22 of the mixing tube 12. In an embodiment, a plurality of magnetic particles 24 may be mixed into the fluid 18 prior to injection through the tube inlet 20 and into the mixing tube 12. In another embodiment, the mixing tube 12 may include a magnetic particle inlet 26 through which magnetic particles 24 are injected into the fluid 18 as the fluid 18 is injected into the mixing tube 12.

In an embodiment, the magnetic particles may be micro sized or nano sized. For example, the magnetic particles may be between about 10 nanometers (nm) and about 20 millimeters (mm), or between about 1000 nm and about 10 mm, or between about 2000 nm and about 5 mm. Further, the magnetic particles 24 may include, for example, iron (e.g., carbonyl iron or iron oxide), cobalt, nickel, and mixtures or alloys of these metals. Additionally, to reduce chemical reactivity of the magnetic particles with the fluid 18, each magnetic particle 24 may be encapsulated within a chemically inert material such as a polymer. A diameter of the hollow center 22 of the mixing tube 12 may be determined by the desired flow rate of the fluid 18, a viscosity of the fluid 18, and the diameter of the plurality of magnetic particles 24. In general, the diameter of the hollow center 22 may be, for example, between about 2 times and about 1 million times the average diameter of the plurality of magnetic particles 24, or between about 10 times and about 10,000 times the average diameter of the plurality of magnetic particles 24.

As the fluid 18 and magnetic particles 24 flow through the mixing tube 12, each electromagnet phase 14, 16 is pulsed out of phase (i.e., out of sync) with the other electromagnet phase(s) to form a varying magnetic field 28 that drives the magnetic particles 24, changes a travel path of the magnetic particles 24, and actively moves the magnetic particles through the fluid 18. The magnetic particles 24 thus move in a direction that resists the natural flow of the fluid 18 through the mixing tube 12. Movement of the magnetic particles 24 through the fluid 18 generates turbulence within the fluid 18, thereby mixing the components of the fluid 18. The frequency and amplitude of the electromagnet phase pulses may be determined in part by the viscosity of the fluid 18 and the size and shape of the magnetic particles 24. In a two-electromagnet phase embodiment, the two electromagnet phases 14, 16 may be activated out of sync, for example 180° out of sync, so that the magnetic particles 24 pulse back and forth within the mixing tube 12. In an embodiment, an axis of each electromagnet phase 14, 16 is parallel with an axis of the mixing tube 12, such that the mixing tube 12 is interposed between the two electromagnet phases 14, 16.

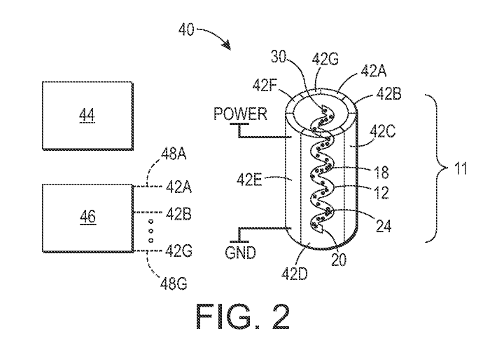

To further enhance mixing or to extend the time the fluid remains in the mixing zone 11 (i.e., the fluid residence time), the mixing tube 12 may include various shapes such as the coil shape depicted in FIG. 1. A coil-shaped mixing tube or receptacle 12 effectively increases the length of travel of the fluid within the mixing zone 11 compared to, for example, a straight mixing tube, and therefore increases mixing time for a given fluid velocity through the mixing tube 12. A coil shape further increases turbulence within the fluid and may therefore improve mixing. In this embodiment, the length of travel through the coiled mixing tube 12 within the mixing zone 11 may be substantially longer than the width (referring to the horizontal arrangement of FIG. 1) of the mixing zone 11 itself, thus providing a compact mixing apparatus design. The mixing tube 12 may be positioned along a generally horizontal axis as depicted in FIG. 1, a generally vertical axis as depicted in FIG. 2, or at an oblique axis.

In an embodiment, the fluid 18 that enters tube inlet 20 may be a minimally mixed solution that is a latex precursor, while the fluid 18 that exits tube outlet 30 is a thoroughly mixed solution that is a latex. The fluid to be mixed that enters the tube inlet 20 of the tube 12 may include a first fluid (i.e., liquid or solution) 60, such as a neutralized resin solution 60 from a first supply or reservoir 62. The fluid to be mixed may further include a second fluid 64, such as DIW 64 from a second supply or reservoir 66. The neutralized resin solution 60 may be pumped from the first supply 62 by a first pump 68 through a first pump inlet 70 that is in fluid communication with the first supply 62 and the first pump 68. The DIW 64 may be pumped from the second supply 66 by a second pump 72 through a second pump inlet 74 that is in fluid communication with the second supply 66 and the second pump 72. The first pump 68 may then pump the first liquid 60 through a first pump outlet 76 to a T-joint 78, and the second pump 72 may pump the second liquid 64 through a second pump outlet 80 to the T-joint 78, wherein an initial mixing or contact of the first fluid 60 and the second fluid 64 to form solution 18 occurs. The fluid 18, which is minimally mixed at the T-joint 78, may be pumped through a T-joint outlet 82, and then to the tube inlet 20. In an embodiment, the T-joint outlet 82 and the mixing tube 12 may be a single continuous tube. In another embodiment, the T-joint outlet 82 may be a individual tube different from the mixing tube 12, but physically coupled to, and in fluid communication with, the mixing tube 12.

In an embodiment, the neutralized resin solution may include a polyester resin dissolved in one or more organic solvents. Any suitable organic solvent may be used to dissolve the polyester resin to form a resin mixture. Suitable organic solvents include, for example, alcohols, esters, ethers, ketones, amines and combinations thereof. Specific examples of organic solvents include, for example, methanol, ethanol, propanol, isopropanol (IPA), butanol, ethyl acetate, methyl ethyl ketone, and the like, and combinations thereof. The organic solvent may be present in an amount of, for example, from about 30% by weight to about 400% by weight of the resin, in embodiments, from about 40% by weight to about 250% by weight of the resin, in embodiments, from about 50% by weight to about 100% by weight of the resin. In embodiments, a solvent mixture can be used, which includes a mixture of two or more solvents. The ratio of any two organic solvents in a solvent mixture may be from about 5:1 to about 50:1, from about 7:1 to about 30:1, or from about 9:1 to about 25:1, or from about 3:1 to about 20:1. In embodiments, a solvent mixture comprises ketone and alcohol.

In embodiments, the organic solvent may be immiscible in water and may have a boiling point of from about 30° C. to about 120° C. In embodiments, the resin solvent solution may include a resin to solvent (i.e., resin:solvent) weight ratio of between about 2:1 and about 1:5, or between about 3:2 and about 1:4, or between about 1:1 and about 1:2. The resin mixture may be neutralized with the neutralizing agent of the present embodiments. Any suitable neutralization agent may be utilized. Examples of neutralizing agents include, for example, ammonium hydroxide, potassium hydroxide, sodium hydroxide, sodium carbonate, sodium bicarbonate, lithium hydroxide, potassium carbonate, triethyl amine, triethanolamine, pyridine, pyridine derivatives, diphenylamine, diphenylamine derivatives, poly(ethylene amine), poly(ethylene amine) derivatives, amine bases and piperazine. Derivatives are defined as any compound or material derived from a base compound, such as pyridine, diphenylamine or poly(ethylene amine), by reaction, addition, alteration, substitution or otherwise.

The neutralizing agent may be present in the aqueous emulsion in an amount of from about 0.001% by weight to about 50% by weight of the resin, in embodiments from about 0.01% by weight to about 25% by weight of the resin, in embodiments from about 0.1% by weight to 5% by weight of the resin. In embodiments, the neutralizing agent may be added in the form of an aqueous solution. In other embodiments, the neutralizing agent may be added in the form of a solid.

In an embodiment, the mixture of the neutralized resin solution 60 and the DIW 64 may initially be brought into contact at the T-joint 78. The residence time of the mixture between the T-joint 78 and the tube outlet 30 may be from about 1 second to about 1 hour, or from about 5 seconds to about 30 minutes, or from about 10 seconds to about 10 minutes. In an embodiment, the latex may be formed without any additional mixing other than that performed between the T-joint 78 and tube outlet 30 inclusive.

Once the solution 18 travels through the mixing zone 11 of FIG. 1, the solution 18 may be ejected or expelled from the mixing tube 12 through a mixing tube outlet 30, for example into another mixing tube 31 to route the fluid to another location. When ejected from the tube outlet 30, the solution 18 is thoroughly mixed. In an embodiment, the magnetic particles 24 are inert, for example if coated with a material such as a stable polymer, which stays suspended within the fluid during use of the fluid. One magnetic particle 24 having a coating 25 is depicted in FIG. 1. The magnetic particles 24 used for mixing of the fluid may provide some utility during use of the fluid, for example as a dry lubricant that forms a plurality of micro- or nano-sized bearings. In another embodiment, the magnetic particles 24 may be removed from the fluid 18 for recycling or for reuse during subsequent fluid mixing. In an embodiment, magnetic particles 24 may be removed or filtered from the fluid 18 by passing the fluid 18 and magnetic particles 24 through a collector 33 that is in fluid communication with the mixing tube outlet 30. In an embodiment, collector 33 may be a mesh filter, wherein openings through the mesh are smaller than the magnetic particles 24. In another embodiment, collector 33 may be a magnet over which the magnetic particles 24 are passed to remove the magnetic particles 24 from the non-magnetic fluid 18. In another embodiment, collector 33 may be a centrifugal filter that removes 24 from the fluid 18 using a centrifugal process, as long as the process does not result in undue separation of the mixed components of the fluid 18.

The FIG. 1 system thus improves mixing of the fluid 18 by electrically activating the electromagnet phases (which may be two or more phases of two or more electromagnets, or two or more phases of a single electromagnet) to magnetically control the movement of the magnetic particles 24 through the fluid 18. An embodiment may further include other elements that improve mixing of the fluid 18. For example, FIG. 1 further depicts one or more heating and/or cooling structures 34 that provide a heating and/or cooling zone. The heating and/or cooling structures 34 may be an electric heater/cooler, a blower, etc. having an output 36 that changes the temperature of the fluid 18 within the mixing tube 12. In an embodiment, the heating and/or cooling zone may be an area interposed between the one or more heating and/or cooling structures 34. In another embodiment, the heating/cooling zone may be an area where the temperature of the fluid 18 is influenced or changed by structures 34. The heating and/or cooling zone may be congruent or non-congruent with the mixing zone 11, for example depending on the length of the heating and/or cooling structures 34 or the area where temperature is influenced by structures 34. It will be appreciated that structure 34 may be a single heating and/or cooling structure 34 that surrounds the cooling zone, or a plurality of individual structures that cooperate to heat and/or cool the fluid 18 as it passes through the mixing zone 11. Heating the fluid 18 with structures 34 may be useful in decreasing the viscosity of the fluid 18 within the mixing tube 12 and increasing the speed of a chemical reaction between the components within the mixing tube 12 in certain uses. Cooling the fluid 18 with structures 34 may be useful in increasing the viscosity of the fluid 18 within the mixing tube 12 and decreasing the speed of a chemical reaction between components within the mixing tube 12 in certain uses.

FIG. 2 is a schematic perspective depiction of a system 40 in accordance with an embodiment of the present teachings having a plurality of electromagnet phases, for example eight electromagnet phases 42A-42G that completely surround the mixing tube 12 through 360°. The electromagnet phases 42A-42G may be a eight of phases of a single electromagnet, or eight phases of eight different electromagnets. Each electromagnet phase 42A-42G may be independently powered through a power and ground connection (only one of which is schematically depicted in FIG. 2) to each electromagnet phase. A power supply 44 may be used to power the electromagnets 42A-42G, and may also power a controller 46. The controller 46, through an independent signal 48A-48G to each electromagnet phase 42A-42G, activates each electromagnet phase in succession to control the movement of the magnetic particles 24 within the fluid 18 in the mixing tube 12. The controller 46 may include electronics such as control relays for switching the direction of the magnetic field between the two or more electromagnet phases.

Thus, an arrangement of the mixing tube 12 and actuation of the electromagnet phases 42A-42G by the controller 46 may be designed to provide efficient mixing of the fluid 18 within the mixing tube 12 within a mixing zone 11 that is compact. For example, in an embodiment, the mixing tube 12 may coil in a first direction (for example clockwise or counterclockwise) from the bottom to the top. The fluid 18 may be dispensed into the mixing tube 12 through the tube inlet 20 at the bottom of the mixing tube 12 and mixed within the mixing tube 12 using the magnetic particles 24. After mixing, the fluid 18 exits through the tube outlet 30.

In an embodiment, the controller 46 may activate each electromagnet phase 42A-42G successively in a second direction that is opposite to the first direction (for example counterclockwise or clockwise) such that the magnetic particles 24 resist the flow of the fluid 18 from the inlet 20 to the mixing tube outlet 30, thus providing a higher turbulence within the fluid for effective mixing of fluid 18 components within the mixing tube 12. Further, the controller 46 may vary the direction of the electromagnet phase activation from counterclockwise to clockwise during the mixing process to further increase turbulence. Various other magnetic particle 24 travel patterns and mixing tube arrangements are contemplated.

The present teachings may thus provide a continuous process for manufacturing a fluid such as a polyester latex, for example for EA toner applications. In an embodiment, a neutralized resin solution and DIW may be brought into contact by being continuously pumped together using separate feeding pumps followed by immediate mixing through a magnetic mixing process within a mixing zone. The mixing zone may be geometrically designed to have a shape than enhances the mixing process when used in tandem with magnetic mixing particles dispersed within the fluid. In an embodiment, a mixing system 10 may include an inlet 70 for continuously flowing a resin solution 60 that is pre-loaded with ammonium hydroxide as neutralization agent. The mixing system 10 may further include an inlet 74 for continuously flowing DIW 64. The mixing system 10 may further include a pulsed pump 68 to pump the resin solution 60 and a pulsed pump 72 to pump the DIW 64. The system 10 may further include a T-joint 78 as a phase inversion zone to allow direct physical mixing and contact between DIW 64 and the resin solution 60.The mixing system 10 may further include a first electromagnet phase 14 and a second electromagnet phase 16 (i.e., a pair of electromagnets) and a high-current power supply 44 to provide required magnetic field 28. The mixing system 10 may further include a mixing zone 11 loaded with magnetic particles 24, and an outlet 30 from which latex flows as prepared.

Thus an embodiment of the present teachings may provide a simple magnetic mixing device that may eliminate any external mixer. The mixing zone may be designed with a 3D geometric shape selected to enhance mixing efficiency. An embodiment of the present teachings may provide a system with reduced device complexity and a simplified and less costly system maintenance compared to some conventional mixing systems.

Thus, an embodiment of the present teachings may include a continuous magnetic mixing process and structure that has minimal geometric limitations on the size and shape of the mixing zone 11. The apparatus and process does not require an external mixer such as an impeller. A varying magnetic field is provided by two or more electromagnetic phases with flexible design consideration, for example, with respect to a horizontal, vertical, or oblique flowing direction. The design may increase reactant loading in a compact layout, enhance heat transfer effectiveness, reduce manufacturing costs, alleviate difficulty on machining process, and allow for simpler maintenance compared to some mixing systems. A continuous mixing system in accordance with an embodiment of the present teachings may have a decreased size, reduced equipment complexity and machining strictness, and enhanced energy utilization, for example heat transfer efficiency. Magnetic particles are introduced into a fluid including one or more components to be mixed. A magnetic field is supplied and varied along the flowing direction to introduce designed travel patterning of the magnetic particles in the flow. This process may introduce continuous mixing in any geometric design of the mixing zone, such as a coil-shaped mixing zone.

The continuous mixing process and structure may be used during the manufacture of various materials such as during the preparation of printer and other toners, inks, wax, pigment dispersions, paints such as latex paints, photoreceptor materials, pharmaceuticals, and the like.

It will be understood that the embodiments depicted in the FIGS. are generalized schematic illustrations and that other components may be added or existing components may be removed or modified.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

While the present teachings have been illustrated with respect to one or more implementations, alterations and/or modifications can be made to the illustrated examples without departing from the spirit and scope of the appended claims. For example, it will be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It will be appreciated that structural components and/or processing stages can be added or existing structural components and/or processing stages can be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items can be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. Finally, “exemplary” indicates the description is used as an example, rather than implying that it is an ideal. Other embodiments of the present teachings will be apparent to those skilled in the art from consideration of the specification and practice of the disclosure herein. It is intended that the specification and examples be considered as exemplary only, with a true scope and spirit of the present teachings being indicated by the following claims.

Terms of relative position as used in this application are defined based on a plane parallel to the conventional plane or working surface of a workpiece, regardless of the orientation of the workpiece. The term “horizontal” or “lateral” as used in this application is defined as a plane parallel to the conventional plane or working surface of a workpiece, regardless of the orientation of the workpiece. The term “vertical” refers to a direction perpendicular to the horizontal. Terms such as “on,” “side” (as in “sidewall”), “higher,” “lower,” “over,” “top,” and “under” are defined with respect to the conventional plane or working surface being on the top surface of the workpiece, regardless of the orientation of the workpiece.

1. A system for mixing a fluid, comprising:
a first pump in fluid communication with a first fluid supply and configured to pump a first fluid from the first fluid supply to a receptacle;
a second pump in fluid communication with a second fluid supply and configured to pump the second fluid from the second fluid supply to the receptacle;
a first electromagnet having a first phase and a second electromagnet having a second phase, wherein the receptacle is interposed between the first electromagnet and the second electromagnet; and
a controller configured to activate the first phase out of phase with the second phase.

2. The system of claim 1, further comprising a plurality of magnetic particles wherein the first electromagnet and the second electromagnet are configured to change a travel path of the plurality of magnetic particles within the receptacle during a mixing process.

3. The system of claim 2, further comprising a chemically inert coating covering each of the plurality of magnetic particles.

4. The system of claim 2, wherein the first fluid and the second fluid is within the receptacle and the plurality of magnetic particles are within the first fluid and the second fluid.

5. The system of claim 4, further comprising:
a receptacle inlet; and
a receptacle outlet, wherein the fluid mixing system is configured to mix the first fluid and the second fluid as the first fluid and the second fluid flows through the receptacle from the receptacle inlet to the receptacle outlet, wherein the first fluid and the second fluid are a latex precursor at the receptacle inlet and a latex at the receptacle outlet.

6. The system of claim 5, further comprising a collector in fluid communication with the receptacle outlet to collect used magnetic particles.

7. The system of claim 2, wherein each magnetic particle of the plurality of magnetic particles has a size in the range of from 10 nanometers to 10 millimeters.

8. The system of claim 1, wherein the receptacle is a coiled mixing tube.

9. The system of claim 8, further comprising:
a plurality of electromagnets that surround the coiled mixing tube in its entirety, wherein each of the plurality of electromagnets comprises a phase;
the coiled mixing tube comprises a mixing tube inlet and a mixing tube outlet;
the coiled mixing tube is wound in a first direction from the mixing tube inlet to the mixing tube outlet; and
the controller is configured to electrically activate the plurality of phases of the plurality of electromagnets successively in the first direction.

10. The system of claim 9, wherein the controller is further configured to electrically activate the plurality of phases of the plurality of electromagnets successively in a second direction that is opposite to the first direction.

11. The system of claim 1, further comprising at least one of a heating zone and a cooling zone surrounding the receptacle.

12. A system for mixing a fluid, comprising:
a first pump in fluid communication with a first fluid supply and configured to pump a first fluid from the first fluid supply to a receptacle;
a second pump in fluid communication with a second fluid supply and configured to pump the second fluid from the second fluid supply to the receptacle;
an electromagnet comprising a first phase and a second phase, wherein the receptacle is interposed between the first phase and the second phase; and
a controller configured to activate the first phase out of phase with the second phase.

13. The system of claim 12, further comprising a plurality of magnetic particles wherein the first phase and the second phase are configured to change a travel path of the plurality of magnetic particles during a mixing process.

14. The system of claim 13, further comprising:
a receptacle inlet; and
a receptacle outlet, wherein the fluid mixing system is configured to mix the first fluid and the second fluid as the first fluid and the second fluid flows through the receptacle from the receptacle inlet to the receptacle outlet, wherein the first fluid and the second fluid are a latex precursor at the receptacle inlet and a latex at the receptacle outlet.

15. A method for continuous mixing of a fluid, comprising:
pumping a first fluid from a first fluid supply into a mixing receptacle using a first pump;
pumping a second fluid to be mixed from a second fluid supply into the mixing receptacle using a second pump, wherein the first fluid within the mixing receptacle and the second fluid within the mixing receptacle form a solution to be mixed;
introducing a plurality of magnetic particles into the mixing receptacle, wherein the plurality of magnetic particles are within the solution to be mixed;
activating a first electromagnet phase; and
activating a second electromagnet phase out of phase with the activation of the first electromagnet phase as the solution to be mixed and the magnetic particles are within the mixing receptacle, thereby altering a travel path of the plurality of magnetic particles within the solution to be mixed, wherein the mixing receptacle is interposed between the first electromagnet phase and the second electromagnet phase.

16. The method of claim 15, wherein the mixing receptacle is a coiled mixing tube comprising a mixing tube inlet and a mixing tube outlet, and the method further comprises:
pumping the solution to be mixed into the mixing tube inlet;
flowing the solution to be mixed and the plurality of magnetic particles through the coiled mixing tube and out of the coiled mixing tube through the mixing tube outlet during the activation of the first electromagnet phase and the activation of the second electromagnet phase out of phase with the first electromagnet phase.

17. The method of claim 16, wherein the introduction of the plurality of magnetic particles into the solution to be mixed introduces a plurality of magnetic particles comprising at least one of iron, cobalt, nickel, and mixtures and alloys thereof.

18. The method of claim 16, wherein the coiled mixing tube is coiled in a first direction from the mixing tube inlet to the mixing tube outlet and the method further comprises activating a plurality of electromagnet phases successively in a second direction that is opposite to the first direction.

19. The method of claim 18, further comprising activating the plurality of electromagnet phases successively in the first direction.

20. The method of claim 15, wherein:
the first fluid comprises a neutralized resin solution;
the second fluid comprises deionized water;
the receptacle comprises an inlet and an outlet;
the method further comprises:
mixing the neutralized resin solution and the deionized water to form a latex precursor to be mixed;
introducing the latex precursor through the receptacle inlet into the receptacle;
performing the activation of the first electromagnet phase and the second electromagnet phase out of phase with the activation of the first electromagnet phase to convert the latex precursor to a latex; and
pumping the latex out of the receptacle outlet.
